(19) United States
(12) Patent Application Publication
(10) Pub. No.: US 2025/0075390 A1
(43) Pub. Date: Mar. 6, 2025

(54) WASHING MACHINE FLUID SYSTEM DIAGNOSIS USING SOUND SIGNALS

(71) Applicant: Haier US Appliance Solutions, Inc., Wilmington, DE (US)

(72) Inventors: MyungGeon Chung, Seoul (KR); Jihwan Kim, Seoul (KR); Je Kwon Yoon, San Jose, CA (US); Seonghoon Ryu, Suwon (KR)

(21) Appl. No.: 18/458,740

(22) Filed: Aug. 30, 2023

(51) Int. Cl. D06F 33/47; D06F 33/34; D06F 34/14; D06F 39/08; F16K 37/00; G01L 11/04; G01M 99/00

(52) U.S. Cl. CPC D06F 33/47; D06F 33/34; D06F 34/14; D06F 39/088; F16K 37/0091; G01L 11/04; G01M 99/005; D06F 2103/14; D06F 2105/02; D06F 2105/58

(57) ABSTRACT

A method of operating a washing machine appliance includes flowing a wash liquid into or within the washing machine appliance and monitoring a sound with a microphone of the washing machine appliance during flowing the wash liquid. The method also includes analyzing the monitored sound and determining a status of a fluid circulation system of the washing machine appliance based on the analysis of the sound.

### FIELD OF THE INVENTION

The present subject matter relates generally to washing machine appliances, and more particularly to methods of monitoring or diagnosing fluid circulation systems of such appliances.

### BACKGROUND OF THE INVENTION

Washing machine appliances generally include a wash tub for containing water or wash fluid (e.g., water, detergent, bleach, or other wash additives). A basket is rotatably mounted within the wash tub and defines a wash chamber for receipt of articles for washing. During normal operation of such washing machine appliances, the wash fluid is directed into the wash tub and onto articles within the wash chamber of the basket. The basket or an agitation element can rotate at various speeds to agitate articles within the wash chamber, to wring wash fluid from articles within the wash chamber, etc.

In some instances however, the wash fluid may not reach the wash tub at all, or less than a desired or intended volume of wash fluid may reach the wash tub. For example, when a water supply to which the washing machine appliance is connected provides low water pressure to the washing machine appliance, less than the desired or intended volume of water may be flowed to the wash tub during operation. As another example, when a water valve of the washing machine appliance fails to open, or fails to open completely, less than the desired or intended volume of water may be flowed to the wash tub during operation. As a further example, when a water supply conduit, e.g., hose, connected to the washing machine appliance become kinked or otherwise obstructed, less than the desired or intended volume of water may be flowed to the wash tub during operation. When less than the desired or intended volume of water may be flowed to the wash tub during operation, the operation may be negatively impacted, such as articles may not be fully cleaned or additives, such as detergent or bleach, dispensed during the operation may not be diluted appropriately when mixed with the lower than expected volume of water.

As a result, it is desired in the art to provide systems and methods for monitoring the status of components of the fluid circulation system and diagnosing issues with one or more such components in a washing machine appliance.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of operating a washing machine appliance is provided. The method includes flowing a wash liquid into or within the washing machine appliance and monitoring a sound with a microphone of the washing machine appliance during flowing the wash liquid. The method also includes analyzing the monitored sound and determining a status of a fluid circulation system of the washing machine appliance based on the analysis of the sound.

In another exemplary aspect of the present disclosure, a washing machine appliance is provided. The washing machine appliance includes a controller. The controller is configured for flowing a wash liquid into or within the washing machine appliance and monitoring a sound with a microphone of the washing machine appliance during flowing the wash liquid. The controller is also configured for analyzing the monitored sound and determining a status of a fluid circulation system of the washing machine appliance based on the analysis of the sound.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance according to one or more exemplary embodiments of the present disclosure.

FIG. 2 provides a cross-sectional side view of the exemplary washing machine appliance.

FIG. 3 provides a schematic view of a system for remote operation of an appliance according to exemplary embodiments of the present subject matter.

FIG. 4 provides a schematic view of an exemplary fluid circulation system for a washing machine appliance, such as the washing machine appliance of FIGS. 1 and 2, according to one or more exemplary embodiments of the present disclosure.

FIG. 5 provides an exemplary spectrogram according to one or more exemplary embodiments of the present disclosure.

FIG. 6 provides another exemplary spectrogram according to one or more exemplary embodiments of the present disclosure.

FIG. 7 provides a flow diagram of an exemplary method of operating a washing machine appliance according to one or more exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In order to aid understanding of this disclosure, several terms are defined below. The defined terms are understood to have meanings commonly recognized by persons of ordinary skill in the arts relevant to the present invention. The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one element from another and are not intended to signify location or importance of the individual elements. Terms such as “inner” and “outer” refer to relative directions with respect to the interior and exterior of the washing machine appliance, and in particular the wash basket therein. For example, “inner” or “inward” refers to the direction towards the interior of the washing machine appliance. Terms such as “left,” “right,” “front,” “back,” “top,” or “bottom” are used with reference to the perspective of a user accessing the washing machine appliance. For example, a user stands in front of the washing machine appliance to open the door and reaches into the wash basket to access items therein. Furthermore, it should be appreciated that as used herein, terms of approximation, such as “approximately,” “substantially,” or “about,” refer to being within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counterclockwise.

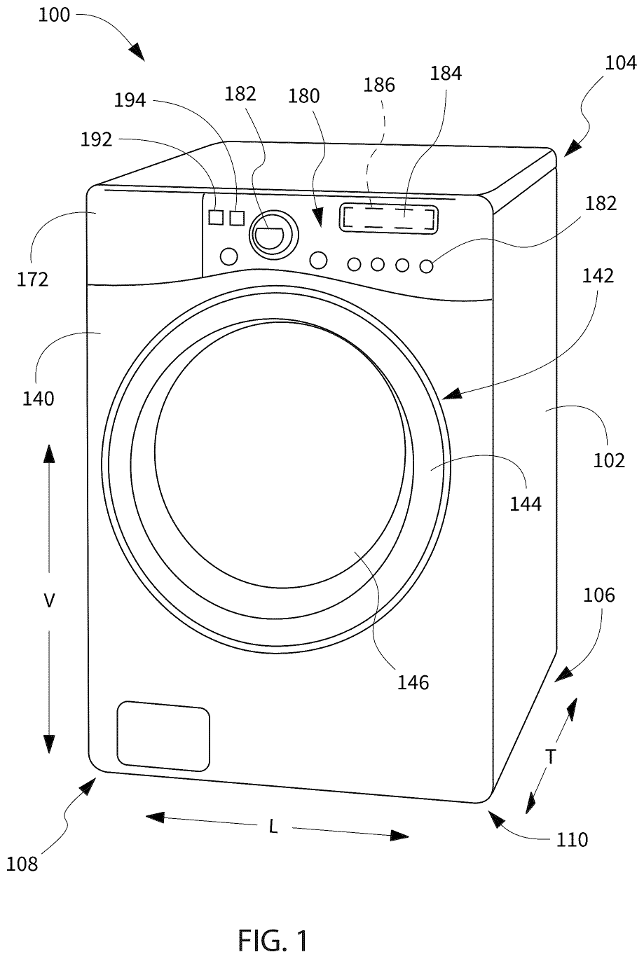

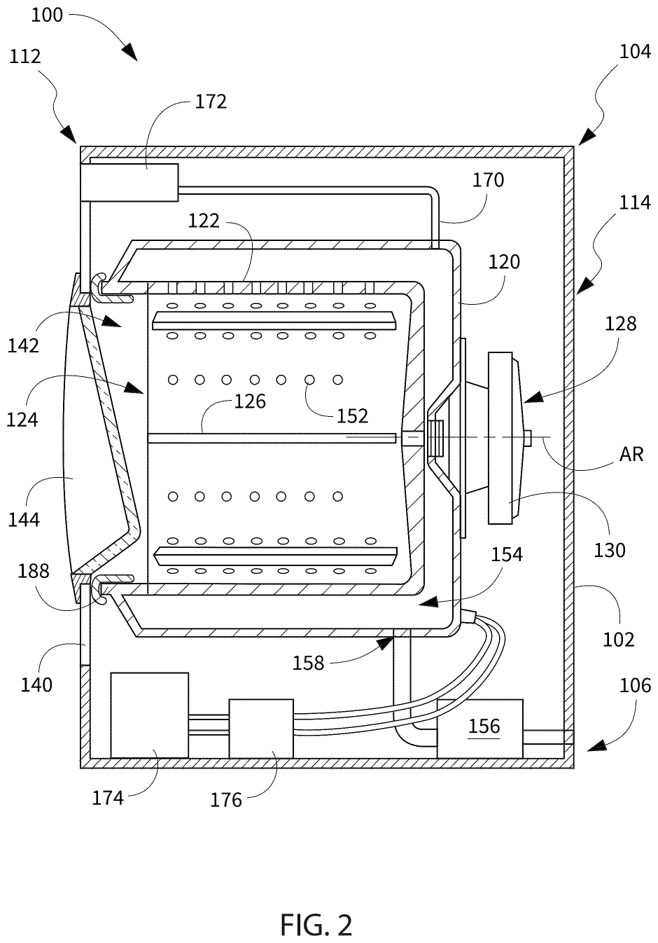

Referring now to the figures, FIG. 1 is a perspective view of an exemplary horizontal axis washing machine appliance 100 and FIG. 2 is a side cross-sectional view of washing machine appliance 100. As illustrated, washing machine appliance 100 generally defines a vertical direction V, a lateral direction L, and a transverse direction T, each of which is mutually perpendicular, such that an orthogonal coordinate system is generally defined. Washing machine appliance 100 includes a cabinet 102 that extends between a top 104 and a bottom 106 along the vertical direction V, between a left side 108 and a right side 110 along the lateral direction L. and between a front 112 and a rear 114 along the transverse direction T.

Referring to FIG. 2, a wash tub 120 is positioned within cabinet 102 and is generally configured for retaining wash fluids during an operating cycle. As used herein, “wash fluid” or “wash liquid” may refer to water, detergent, fabric softener, bleach, or any other suitable wash additive or combination thereof. A wash basket 122 is received within wash tub 120 and defines a wash chamber 124 that is configured for receipt of articles for washing. More specifically, wash basket 122 is rotatably mounted within wash tub 120 such that it is rotatable about an axis of rotation AR. According to the illustrated embodiment, the axis of rotation is substantially parallel to the transverse direction T. In this regard, washing machine appliance 100 is generally referred to as a “horizontal axis” or “front load” washing machine appliance 100. However, it should be appreciated that aspects of the present subject matter may be used within the context of a vertical axis or top load washing machine appliance as well.

Wash basket 122 may define one or more agitator features that extend into wash chamber 124 to assist in agitation and cleaning articles disposed within wash chamber 124 during operation of washing machine appliance 100. For example, as illustrated in FIG. 2, a plurality of ribs 126 extends from basket 122 into wash chamber 124. In this manner, for example, ribs 126 may lift articles disposed in wash basket 122 during rotation of wash basket 122.

Washing machine appliance 100 includes a drive assembly 128 which is coupled to wash tub 120 and is generally configured for rotating wash basket 122 during operation, e.g., such as during an agitation or spin cycle. More specifically, as best illustrated in FIG. 2, drive assembly 128 may include a motor assembly 130 that is in mechanical communication with wash basket 122 to selectively rotate wash basket 122 (e.g., during an agitation or a rinse cycle of washing machine appliance 100). According to the illustrated embodiment, motor assembly 130 is a pancake motor. However, it should be appreciated that any suitable type, size, or configuration of motors may be used to rotate wash basket 122 according to alternative embodiments. In addition, drive assembly 128 may include any other suitable number, types, and configurations of support bearings or drive mechanisms.

Referring generally to FIGS. 1 and 2, cabinet 102 also includes a front panel 140 that defines an opening 142 that permits user access to wash basket 122. More specifically, washing machine appliance 100 includes a door 144 that is positioned over opening 142 and is rotatably, e.g., pivotably, mounted to front panel 140 (e.g., about a door axis that is substantially parallel to the vertical direction V). In this manner, door 144 permits selective access to opening 142 by being movable between an open position (not shown) facilitating access to a wash tub 120 and a closed position (FIG. 1) prohibiting access to wash tub 120. For example, when the door 144 is in the closed position, the wash tub 120 may be generally enclosed by the door 144 and the cabinet 102. A gasket 188 may be provided in the opening 142 and the gasket 188 may sealingly engage the door 144 when the door 144 is in the closed position. For example, the gasket 188 may extend between the tub 120 and the front panel 140, e.g., generally along the transverse direction T and may extend about or around the opening 142 such that the gasket 188 is covered by the door 144 when the door 144 is in the closed position, and the gasket 188 may promote sealing between the door 144 and the cabinet 102, e.g., the front panel 140 of the cabinet 102.

In some embodiments, a window 146 in door 144 permits viewing of wash basket 122 when door 144 is in the closed position (e.g., during operation of washing machine appliance 100). Door 144 also includes a handle (not shown) that, for example, a user may pull when opening and closing door 144. Further, although door 144 is illustrated as mounted to front panel 140, it should be appreciated that door 144 may be mounted to another side of cabinet 102 or any other suitable support according to alternative embodiments.

Referring again to FIG. 2, wash basket 122 also defines a plurality of perforations 152 in order to facilitate fluid communication between an interior of basket 122 and wash tub 120. A sump 154 is defined by wash tub 120 at a bottom of wash tub 120 along the vertical direction V. Thus, sump 154 is configured for receipt of, and generally collects, wash fluid during operation of washing machine appliance 100. For example, during operation of washing machine appliance 100, wash fluid may be urged (e.g., by gravity) from basket 122 to sump 154 through the plurality of perforations 152. A pump assembly 156 is located beneath wash tub 120 for gravity assisted flow when draining wash tub 120 (e.g., via a drain 158). Pump assembly 156 is also configured for recirculating wash fluid within wash tub 120. Accordingly, pump assembly 156 may also be referred to or include a drain pump and/or a circulation pump.

Referring still to FIGS. 1 and 2, in some embodiments, washing machine appliance 100 may include an additive dispenser or spout 170. For example, spout 170 may be in fluid communication with a water supply (not shown) in order to direct fluid (e.g., clean water) into wash tub 120. Spout 170 may also be in fluid communication with the sump 154. For example, pump assembly 156 may direct wash fluid disposed in sump 154 to spout 170 in order to circulate wash fluid in wash tub 120.

As illustrated, a detergent drawer 172 may be slidably mounted within front panel 140. Detergent drawer 172 receives a wash additive (e.g., detergent, fabric softener, bleach, or any other suitable liquid or powder) and directs the fluid additive to wash chamber 124 during operation of washing machine appliance 100. According to the illustrated embodiment, detergent drawer 172 may also be fluidly coupled to spout 170 to facilitate the complete and accurate dispensing of wash additive.

In some embodiments, an optional bulk reservoir 174 may be disposed within cabinet 102. Bulk reservoir 174 may be configured for receipt of fluid additive for use during operation of washing machine appliance 100. Moreover, bulk reservoir 174 may be sized such that a volume of fluid additive sufficient for a plurality or multitude of wash cycles of washing machine appliance 100 (e.g., five, ten, twenty, fifty, or any other suitable number of wash cycles) may fill bulk reservoir 174. Thus, for example, a user can fill bulk reservoir 174 with fluid additive and operate washing machine appliance 100 for a plurality of wash cycles without refilling bulk reservoir 174 with fluid additive. A reservoir pump 176 may be configured for selective delivery of the fluid additive from bulk reservoir 174 to wash tub 120.

A control panel 180 including a plurality of input selectors 182 may be coupled to front panel 140. Control panel 180 and input selectors 182 collectively form a user interface input for operator selection of machine cycles and features. A display 184 of control panel 180 indicates selected features, operation mode, a countdown timer, and/or other items of interest to appliance users regarding operation.

Washing machine appliance 100 may also include a microphone 192 and a speaker 194, which are also both communicatively coupled with controller 186, e.g., via communication lines (not shown). Microphone 192 and speaker 194 may be used to receive and output audible commands/responses such that washing machine appliance 100 may be provided with voice control. In this way, washing machine appliance 100, and more specifically controller 186, may operatively communicate with a user to control washing machine appliance 100 by voice command. For example, if a user is standing in the proximity of washing machine appliance 100 and requests to operate washing machine appliance 100 remotely, microphone 192 may pick up the audible command. When microphone 192 picks up the voice command, the communication may be routed from microphone 192 to controller 186. The communication may be processed by one or more voice/speech recognition applications executable by one or more processors of controller 186. Washing machine appliance 100 may communicate with the user via speaker 194, e.g., to confirm a command or instructions. Although microphone 192 and speaker 194 are shown in particular locations in FIG. 1, it will be appreciated that other suitable locations for these various operational components may be used and, if desired, one or more of any of these components may be applied as well. It will also be appreciated that the foregoing description of voice command is by way of example only, in some embodiments, the washing machine appliance 100 may include a microphone 192 and/or speaker 194 for other functions in addition to or instead of the exemplary voice command operations.

Control panel 180, including user inputs 166 and display 184, microphone 192, and speaker 194 collectively make up a user interface 190 of washing machine appliance 100. User interface 190 provides a means for users to communicate with and operate washing machine appliance 100. It will be appreciated that other components or devices that provide for communication with washing machine appliance 100 for operating washing machine appliance 100 may also be included in user interface 190. For example, although not shown, user interface 190 may include a camera or motion detection camera for detecting a user's proximity to washing machine appliance 100 or for picking up certain motions.

Operation of washing machine appliance 100 is controlled by a processing device or a controller 186 that is operatively coupled to control panel 180 for user manipulation to select washing machine cycles and features. In response to user manipulation of control panel 180, controller 186 operates the various components of washing machine appliance 100 to execute selected machine cycles and features. Controller 186 may include a memory and microprocessor, such as a general or special purpose microprocessor operable to execute programming instructions or micro-control code associated with methods described herein. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 186 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 180 may be in communication with controller 186 via one or more signal lines or shared communication busses to provide signals to and/or receive signals from the controller 186.

In addition, the memory or memory devices of the controller 186 can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 186 may be operable to execute programming instructions or micro-control code associated with an operating cycle of washing machine appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 186 as disclosed herein is capable of and may be operable to perform any methods, method steps, or portions of methods as disclosed herein. For example, in some embodiments, methods disclosed herein may be embodied in programming instructions stored in the memory and executed by controller 186.

The memory devices may also store data that can be retrieved, manipulated, created, or stored by the one or more processors or portions of controller 186. The data can include, for instance, data to facilitate performance of methods described herein. The data can be stored locally (e.g., on controller 186) in one or more databases and/or may be split up so that the data is stored in multiple locations. In addition, or alternatively, the one or more database(s) can be connected to controller 186 through any suitable network(s), such as through a high bandwidth local area network (LAN) or wide area network (WAN). In this regard, for example, controller 186 may further include a communication module or interface that may be used to communicate with one or more other component(s) of washing machine appliance 100, controller 186, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

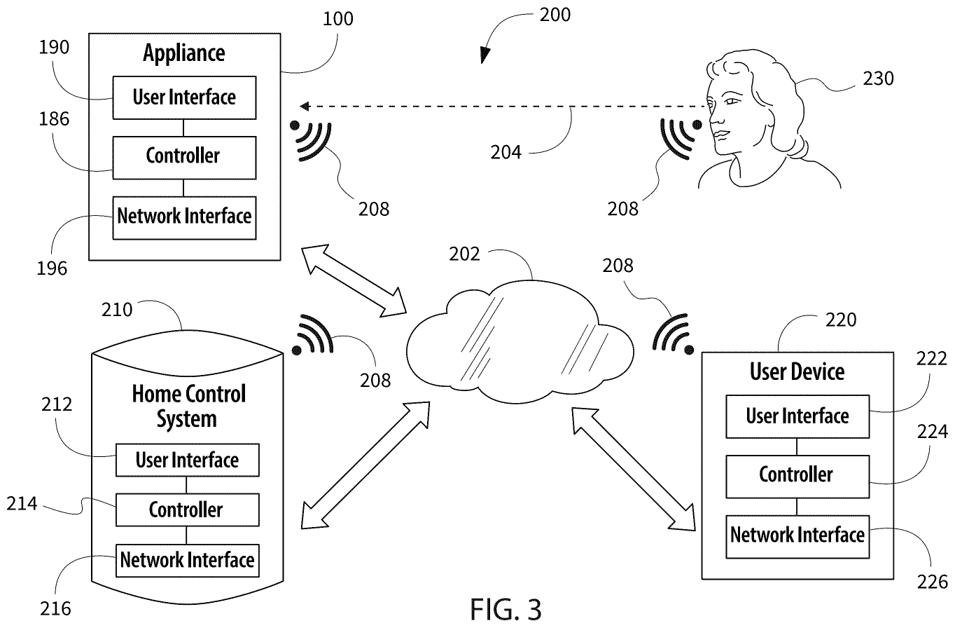

Controller 186 may include a network interface 196 (FIG. 3) such that controller 186 can connect to and communicate over one or more networks with one or more network nodes. Controller 186 can also include one or more transmitting, receiving, and/or transceiving components for transmitting/receiving communications with other devices communicatively coupled with washing machine appliance 100. Additionally or alternatively, one or more transmitting, receiving, and/or transceiving components can be located off board controller 186.

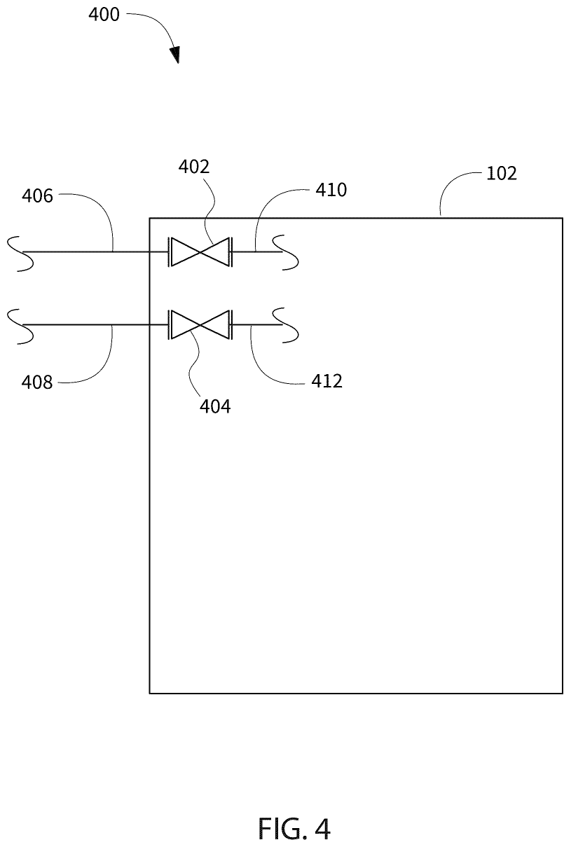

In exemplary embodiments, during operation of washing machine appliance 100, laundry items are loaded into wash basket 122 through opening 142, and a wash operation is initiated through operator manipulation of input selectors 182. For example, a wash cycle may be initiated such that wash tub 120 is filled with water, detergent, or other fluid additives (e.g., via detergent drawer 172 or bulk reservoir 174). One or more valves (see, e.g., valves 402 and 404 in FIG. 4) can be controlled by washing machine appliance 100 to provide for filling wash basket 122 to the appropriate level for the amount of articles being washed or rinsed. By way of example, once wash basket 122 is properly filled with fluid, the contents of wash basket 122 can be agitated (e.g., with ribs 126) for an agitation phase of laundry items in wash basket 122. During the agitation phase, the basket 122 may be motivated about the axis of rotation AR at a set speed, e.g., first speed or tumble speed. As the basket 122 is rotated, articles within the basket 122 may be lifted and permitted to drop therein.

After the agitation phase of the washing operation is completed, wash tub 120 can be drained, e.g., by drain pump assembly 156. Laundry articles can then be rinsed, e.g., through a rinse cycle, by again adding fluid to wash tub 120, depending on the particulars of the cleaning cycle selected by a user. Ribs 126 may again provide agitation within wash basket 122. One or more spin cycles may also be used. In particular, a spin cycle may be applied after the wash cycle or after the rinse cycle in order to wring wash fluid from the articles being washed. During a spin cycle, basket 122 is rotated at relatively high speeds. For instance, basket 122 may be rotated at one set speed, e.g., second speed or pre-plaster speed before being rotated at another set speed, e.g., third speed or plaster speed. As would be understood, the pre-plaster speed may be greater than the tumble speed and the plaster speed may be greater than the pre-plaster speed. Moreover, agitation or tumbling of articles may be reduced as basket 122 increases its rotational velocity such that the plaster speed maintains the articles at a generally fixed position relative to basket 122. After articles disposed in wash basket 122 are cleaned (or the washing operation otherwise ends), a user can remove the articles from wash basket 122, e.g., by opening door 144 and reaching into wash basket 122 through opening 142.

During such operations, the gasket 188 may help to contain wash fluid within the cabinet 102, particularly within the tub 120. As generally shown in FIG. 2, the gasket 188 may be positioned between the door 144 and the tub 120, e.g., when the door 144 is in the closed position as in FIG. 2. Thus, the gasket 188 may sealingly engage the door 144 when the door 144 is in the closed position. In general, the gasket 188 sealingly engages the cabinet 102, in particular the opening 142 thereof, the tub 120, and the door 144. For example, the gasket 188 may extend around the opening 142 along a perimeter, e.g., circumference, of the opening 142 and may extend between the cabinet 102 and the wash tub 120 along a longitudinal axis, such as along or generally parallel to the transverse direction T.

It should be appreciated that the present subject matter is not limited to any particular style, model, or configuration of washing machine appliance. The exemplary embodiment depicted in FIGS. 1 and 2 is simply provided for illustrative purposes only. While described in the context of a specific embodiment of horizontal axis washing machine appliance 100, it will be understood that horizontal axis washing machine appliance 100 is provided by way of example only. Other washing machine appliances having different configurations, different appearances, and/or different features may also be utilized with the present subject matter as well. For example, different locations may be provided for the user interface, different configurations may be provided, e.g., vertical axis washing machines, and other differences may be applied as well.

FIG. 3 provides a schematic view of a system 200 for remote operation of washing machine appliance 100 according to exemplary embodiments of the present subject matter. As shown, washing machine appliance 100 can be communicatively coupled with network 202 and various other nodes, such as an intelligent home control system 210 and one or more user devices 220. In some embodiments, home control system 210 is considered a user device. Moreover, one or more users 230 can be in operative communication with washing machine appliance 100, home control system 210, and/or user devices 220 by various methods, including voice control 208 or motion detection, for example. Additionally, or alternatively, although network 202 is shown, washing machine appliance 100 and home control system 210, user devices 220, and/or other devices within system 200 need not be communicatively coupled via network 202; rather, washing machine appliance 100 and the devices of system 200 can be communicatively coupled via any suitable wired or wireless means not over network 202, such as e.g., via physical wires, transceiving, transmitting, and/or receiving components.

Network 202 can be any suitable type of network, such as a local area network (e.g., intranet), wide area network (e.g., internet), low power wireless networks, e.g., Bluetooth Low Energy (BLE), or some combination thereof and can include any number of wired or wireless links. In general, communication over network 202 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

Intelligent home control system 210 can be communicatively coupled with washing machine appliance 100 and/or one or more user devices 230 via network 202. Additionally, home control system 210 can be in operative communication with users 230 via voice control 208, for example. Home control system 210 can be or include a smart device, such as a smart speaker, for example an Amazon Echo manufactured by Amazon.com, Inc., or other similar device configured with a digital personal assistant, e.g., “Alexa” by Amazon.com, Inc., for receiving and carrying out voice commands, for example. However, home control system 210 can be any suitable type of control system.

Home control system 210 can include one or more speakers and one or more microphones for receiving/sending audible inputs/outputs for voice control 208. This allows users 230 to communicate with home control system 210 via voice commands and vice versa, for example. Collectively, the speakers, microphones, and other communication devices of home control system 210 make up control system user interface 212.

Home control system 210 can include one or more home control system controllers 214 communicatively coupled with user interface 212. Controller 214 includes one or more processors and one or more memory devices. The one or more processors can be any suitable processing device (e.g., a processor core, a microprocessor, an ASIC, a FPGA, a microcontroller, etc.) and can be one processor or a plurality of processors that are operatively connected. The memory device can include one or more non-transitory computer-readable storage mediums, such as RAM, ROM, EEPROM, EPROM, flash memory devices, magnetic disks, etc., and combinations thereof. The memory devices can store data and instructions which are executed by the processor to cause home control system 210 to perform operations. For example, instructions could be instructions for voice/speech recognition. Controller 214 includes a control system network interface 216 such that home control system 210 can connect to and communicate over one or more networks. Network interface 216 can be an onboard component of controller 214 or it can be a separate, off board component. Controller 214 can also include one or more transmitting, receiving, and/or transceiving components for transmitting/receiving communications with other devices communicatively coupled with home control system 210. Additionally or alternatively, one or more transmitting, receiving, and/or transceiving components can be located off board controller 214.

User device 220 is communicatively coupled with network 202 such that user device 220 can communicate with washing machine appliance 100. User device 220 can communicate directly with washing machine appliance 100 via network 202. Alternatively, user device 220 can communicate indirectly with washing machine appliance 100 by communicating via network 202 with home control system 210, which in turn communicates with washing machine appliance 100 via network 202. Moreover, user 230 can be in operative communication with user device 220 such that user 230 can communicate with washing machine appliance 100 via user device 220.

User device 220 can be any type of device, such as, for example, a personal computing device (e.g., laptop or desktop), a mobile computing device (e.g., smartphone or tablet), a gaming console or controller, a wearable computing device, an embedded computing device, a remote, or any other suitable type of user computing device. User device 220 can include one or more user device controllers 224. Controller 224 can include one or more processors and one or more memory devices. The one or more processors can be any suitable processing device (e.g., a processor core, a microprocessor, an ASIC, a FPGA, a controller, a microcontroller, etc.) and can be one processor or a plurality of processors that are operatively connected. The memory device can include one or more non-transitory computer-readable storage mediums, such as RAM, ROM, EEPROM, EPROM, flash memory devices, magnetic disks, etc., and combinations thereof. The memory can store data and instructions which are executed by the processor to cause user device 220 to perform operations. Controller 224 includes a user device network interface 226 such that user device 220 can connect to and communicate over one or more networks. Network interface 226 can be an onboard component of controller 224 or it can be a separate, off board component. Controller 224 can also include one or more transmitting, receiving, and/or transceiving components for transmitting/receiving communications with other devices communicatively coupled with user device 220. Additionally or alternatively, one or more transmitting, receiving, and/or transceiving components can be located off board controller 224.

User device 220 can include one or more user inputs such as e.g., buttons, one or more cameras, and/or a display configured to display graphical user interfaces and/or other visual representations to user 230. For example, the display can display graphical user interfaces corresponding to operational features of washing machine appliance 100 such that user 230 may manipulate or select the features to operate washing machine appliance 100. The display can be a touch sensitive component (e.g., a touch-sensitive display screen or a touch pad) that is sensitive to the touch of a user input object (e.g., a finger or a stylus). For example, a user may touch the display with his or her finger and type in a series of numbers on the display. In addition, motion of the user input object relative to the display can enable user 230 to provide input to user device 220. User device 220 may provide other suitable methods for providing input to user device 220 as well. Moreover, user device 220 can include one or more speakers, one or more cameras, and/or more than one microphones such that user device 220 is configured with voice control 208, motion detection, and other functionality. Collectively, these input and communication devices make up user device user interface 222. As shown, user interface 222 is communicatively coupled with controller 224.

User 230 may be in operative communication with washing machine appliance 100, home control system 210, and/or one or more user devices 220. In some exemplary embodiments, user 230 can communicate with washing machine appliance 100, home control system 210, and/or user device 220 using voice control 208. User 230 may also be in operative communication via other methods as well, such as, e.g., via visual communication 204 as shown in FIG. 3. Although not shown, user 230 may be in visual communication 204 with one or more displays of home control system 210 and/or user device 220 as well.

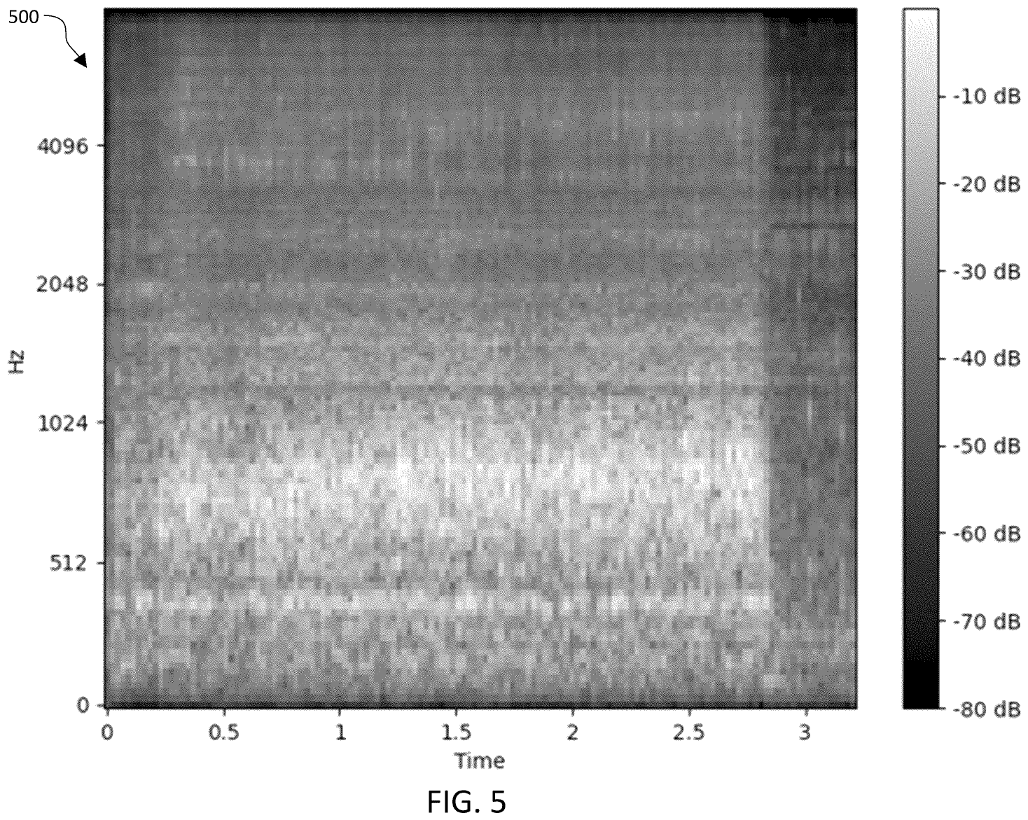

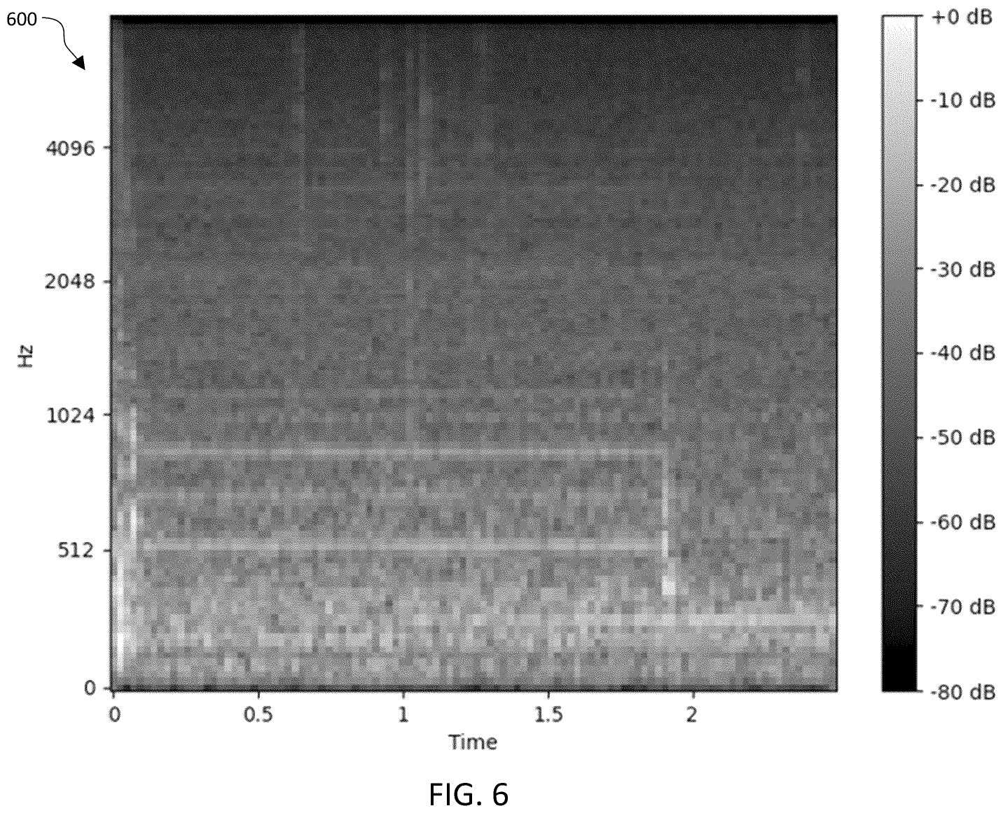

Microphone 192 may be operable to detect and capture other sounds as well as or instead of voice commands as described above. For example, such other sounds may be transmitted to the controller 186 for analysis. Such analysis may include generating a spectrogram of the sound. For example, the spectrogram may be a Mel spectrogram, such as the exemplary Mel spectrogram 500 illustrated in FIG. 5 and the exemplary Mel spectrogram 600 illustrated in FIG. 6. It should be appreciated that the decibel scale in each Mel spectrogram 500 and 600 ranges from a minimum of −80 dB to a maximum of 0 dB, e.g., the volume of the sounds represented by Mel spectrograms 500 and 600 is below the range a human ear can perceive. Sounds which may be captured by the microphone include various sounds emitted during operation of the washing machine appliance 100, e.g., water (and/or other wash liquids) flowing through tubes or other conduits, valves opening and closing, switches toggling, etc. In the particular examples of FIGS. 5 and 6, Mel spectrograms 500 and 600 are spectrograms of a water valve opening (or when the water valve is expected to open, e.g., when an open command is transmitted to the water valve by a controller of the washing machine appliance). In FIG. 5, the water valve is operating as expected, and water is flowing through the valve and conduits coupled thereto, whereas in FIG. 6, no water is flowing, such that the Mel spectrogram 600 of FIG. 6 may correspond to or indicate an abnormal or unexpected operation of the water valve, which is an example of as an abnormal status of the fluid circulation system. For instance, the spectrogram 600 in FIG. 6 may represent or correspond to a situation in which no water is flowing for one or more reasons, such as the valve failed to open, water pressure from a water supply coupled to the valve is low or no water pressure, or other causes including combinations of multiple causes.

An exemplary fluid circulation system 400, e.g., including water valves 402 and 404, either of which may be the water valve from which the sound represented by spectrogram 500 or spectrogram 600 was emitted, is schematically illustrated in FIG. 4. The fluid circulation system 400 includes components both inside of the cabinet 102 and outside of the cabinet 102. For example, the fluid circulation system 400 includes a first conduit 406, e.g., a hot water conduit such as a hot water hose which may be connected to a hot water supply (not shown) at one end thereof and coupled to the washing machine appliance 100 at a first water valve 402, e.g., hot water valve, at another end of the first conduit 406. The fluid circulation system 400 also includes a second conduit 408, e.g., a cold water conduit such as a cold water hose which may be connected to a cold water supply (not shown) at one end thereof and coupled to the washing machine appliance 100 at a second water valve 404, e.g., cold water valve, at another end of the second conduit 408. Referring back to FIG. 2, other components of the washing machine appliance 100 may be downstream of one or both of the water valves 402 and/or 404, such as the spout 170, detergent drawer 172, and/or tub 120. For example, water may be provided to such other components via a first downstream conduit 410 and/or a second downstream conduit 412, each of which is downstream of a respective one of the water valves 402 and 404, e.g., as may be seen in FIG. 4.

Now that the construction of washing machine appliance 100 and the configuration of controller 186 according to exemplary embodiments have been presented, exemplary methods of operating a washing machine appliance will be described. Although the discussion below refers to the exemplary method 700 of operating washing machine appliance 100, one skilled in the art will appreciate that the exemplary method 700 is applicable to the operation of a variety of other washing machine appliances, such as vertical axis washing machine appliances or combination washer-dryer appliances. In exemplary embodiments, the various method steps as disclosed herein may be performed, e.g., in whole or part, by controller 186 or another, separate, dedicated controller, and/or by one or more remote computing devices, such as in a distributed computing environment, e.g., in the cloud, the fog, or the edge.

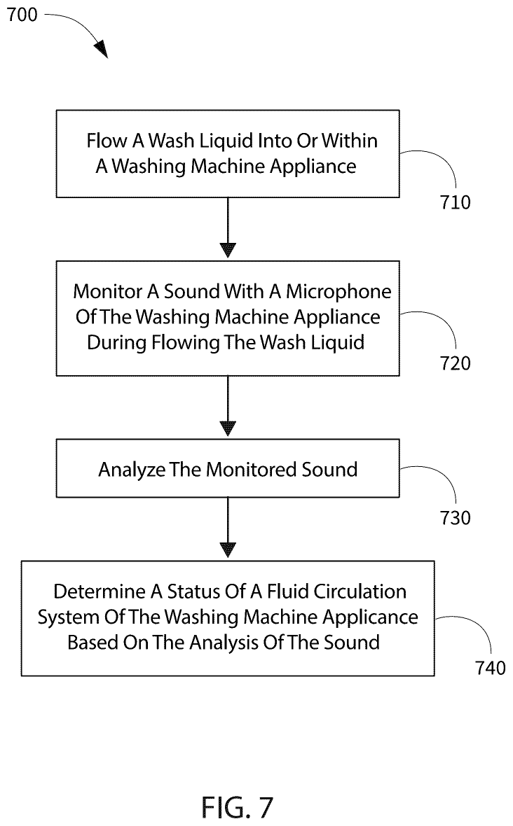

FIG. 7 depicts steps performed in a particular order for purpose of illustration and discussion. Those of ordinary skill in the art, using the disclosures provided herein, will understand that the steps of the method 700 can be modified, adapted, rearranged, omitted, interchanged, or expanded in various ways without deviating from the scope of the present disclosure.

FIG. 7 illustrates an exemplary method 700 of operating a washing machine appliance, according to one or more exemplary embodiments of the present disclosure. Method 700 can be implemented using any suitable washing machine appliance, including for example, the illustrated horizontal axis washing machine appliance 100 described hereinabove. Accordingly, to provide context to method 700, reference numerals utilized to describe the features of washing machine appliance 100 hereinabove will also be used below.

The method 700 may include flowing a wash liquid into or within the washing machine appliance, e.g., as indicated at 710 in FIG. 7. For example, the wash liquid may be flowed into the washing machine appliance 100 from one or more water supplies, such as through conduit 406 or 408 and/or may be flowed within the washing machine appliance 100, such as to or through the detergent drawer 172, spout 170, and/or tub 120, e.g., from one or both of valves 402 and 404. Thus, in some embodiments, flowing the wash liquid may include opening a water valve and/or may include flowing the wash liquid through a conduit, such as conduit 406 or 408, of the fluid circulation system.

Referring still to FIG. 7, in some embodiments, method 700 may also include monitoring a sound with a microphone of the washing machine appliance during flowing the wash liquid, e.g., as indicated at 720. The monitored sound may be the sound of water flowing (or not flowing, in some cases of abnormal status of the fluid circulation system) through one or more conduits, such as hot water hose 406 or cold water hose 408. The monitored sound may also or instead be the sound of a water valve opening and water flowing (or not) through the water valve, such as hot water valve 402 or cold water valve 404.

Method 700 may further include analyzing the monitored sound (730) and, based on the analysis of the sound, determining a status of a fluid circulation system of the washing machine (740).

In some embodiments, analyzing the sound may include generating a spectrogram of the sound, such as a Mel spectrogram, e.g., as illustrated in FIGS. 5 and 6, and analyzing the spectrogram of the sound with an image analysis technique. The image analysis technique may be computer-implemented, such as a machine learning technique or other image analysis technique. For example, such image analysis may include classifying the spectrogram with an AI classification model, e.g., classifying a level of water flow or water pressure, including potentially an absence of water flow or water pressure, indicated by the sound as reflected in the spectrogram generated from the sound captured by the microphone.

According to exemplary embodiments, this image analysis may use any suitable image processing technique, image recognition process, etc. As used herein, the terms “image analysis” and the like may be used generally to refer to any suitable method of observation, analysis, image decomposition, feature extraction, image classification, etc., of one or more images, e.g., spectrograms. As explained in more detail below, this image analysis may include the implementation of image processing techniques, image recognition techniques, or any suitable combination thereof. It should be appreciated that this image analysis or processing may be performed locally, e.g., by controller 186, or remotely, e.g., by offloading image data to a remote server or network, such as a distributed computing network, as mentioned above.

Specifically, the analysis of the one or more images, e.g., spectrograms, may include implementation of an image processing algorithm. As used herein, the terms “image processing” and the like are generally intended to refer to any suitable methods or algorithms for analyzing images that do not rely on artificial intelligence or machine learning techniques, e.g., in contrast to the machine learning image recognition processes described below. For example, the image processing algorithm may rely on image differentiation, e.g., such as a pixel-by-pixel comparison of two sequential images. This comparison may help identify substantial differences between the sequentially obtained images (such as two sequentially generated spectrograms of sequentially captured sounds), e.g., to identify movement, the presence of a particular object (such as a fluid, e.g., flowing water), the existence of a certain condition, etc. For example, one or more reference images may be obtained when a particular condition exists, and these references images may be stored for future comparison with images obtained during appliance operation. Similarities and/or differences between the reference image and the obtained image, e.g., generated spectrogram, may be used to extract useful information for improving appliance performance. For example, a spectrogram of normal status operation may be a reference image, and the obtained image may be a spectrogram generated during a current operation of the washing machine appliance, such that differences between the reference image and the obtained image may indicate an abnormal status of the fluid circulation system.

In addition to the image processing techniques described above, the image analysis may include utilizing artificial intelligence (“AI”), such as a machine learning image recognition process, a neural network classification module, any other suitable artificial intelligence (AI) technique, and/or any other suitable image analysis techniques, examples of which will be described in more detail below. Moreover, each of the exemplary image analysis or evaluation processes described below may be used independently, collectively, or interchangeably to extract detailed information regarding the images being analyzed to facilitate performance of one or more methods described herein or to otherwise improve appliance operation. According to exemplary embodiments, any suitable number and combination of image processing, image recognition, or other image analysis techniques may be used to obtain an accurate analysis of the obtained images, e.g., generated spectrograms.

In this regard, the image recognition process may use any suitable artificial intelligence technique, for example, any suitable machine learning technique, or for example, any suitable deep learning technique. According to an exemplary embodiment, the image recognition process may include the implementation of a form of image recognition called region based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different than R-CNN. For example, R-CNN first applies a convolutional neural network (“CNN”) and then allocates it to zone recommendations on a property map of one of the convolutional layers, e.g., conv5, instead of the initially split into zone recommendations. In addition, according to exemplary embodiments, standard CNN may be used to obtain, identify, or detect any other qualitative or quantitative data related to one or more objects or regions within the one or more images. In addition, a K-means algorithm may be used.

According to still other embodiments, the image recognition process may use any other suitable neural network process while remaining within the scope of the present subject matter. For example, the step of analyzing the one or more images may include using a deep belief network (“DBN”) image recognition process. A DBN image recognition process may generally include stacking many individual unsupervised networks that use each network's hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described or other known methods may be used while remaining within the scope of the present subject matter.

In addition, it should be appreciated that various transfer techniques may be used but use of such techniques is not required. If using transfer techniques learning, a neural network architecture may be pretrained such as VGG16/VGG19/ResNet50 with a public dataset then the last layer may be retrained with an appliance-specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to exemplary embodiments, this image recognition process relies at least in part on a neural network trained with a plurality of images of the appliance in different configurations, experiencing different conditions, or being interacted with in different manners. This training data may be stored locally or remotely and may be communicated to a remote server for training other appliances and models. According to exemplary embodiments, it should be appreciated that the machine learning models may include supervised and/or unsupervised models and methods. In this regard, for example, supervised machine learning methods (e.g., such as targeted machine learning) may help identify problems, anomalies, or other occurrences which have been identified and trained into the model. By contrast, unsupervised machine learning methods may be used to detect clusters of potential failures, similarities among data, event patterns, abnormal concentrations of a phenomenon, etc.

It should be appreciated that image processing and machine learning image recognition processes may be used together to facilitate improved image analysis, such as image comparison, or to extract other useful qualitative or quantitative data or information from the one or more images that may be used to improve the operation or performance of the appliance. Indeed, the methods described herein may use any or all of these techniques interchangeably to improve image analysis process and facilitate improved appliance performance and consumer satisfaction. The image processing algorithms and machine learning image recognition processes described herein are only exemplary and are not intended to limit the scope of the present subject matter in any manner.

In some embodiments, flowing the wash liquid may include opening a water valve, e.g., as discussed above. In such embodiments, the washing machine appliance may include a controller, and opening the water valve may include sending an open command from the controller to the water valve. Also in such embodiments, monitoring the sound with the microphone of the washing machine appliance during flowing the wash liquid may include activating the microphone by the controller concurrently with sending the open command. Thus, the monitored sound may be or include one or more sounds occurring when the valve opens or is expected to open. For example, such embodiments may also include activating the microphone for a predetermined recording time, such as two or three seconds after commanding the valve to open. As such, the status of the fluid circulation system in such embodiments may be or may include a status of the water valve, such as opened, partially opened, or closed, and/or a water pressure at and through the valve. For example, the status of the water valve, e.g., opened, partially opened, or closed, may be determined by classifying a spectrogram generated from sound captured by the microphone of the washing machine appliance using a machine learning image analysis process.

In some embodiments, flowing the wash liquid may include flowing the wash liquid through a conduit of the fluid circulation system, e.g., as discussed above. In such embodiments, monitoring the sound during flowing the wash liquid may include monitoring the sound at the conduit, and the status of the fluid circulation system may be or may include a pressure within the conduit, such as a low water pressure, medium water pressure, or high water pressure. In such embodiments, medium and/or high water pressure may be considered normal or expected water pressure, whereas the low water pressure in the conduit may be considered an abnormal status of the fluid circulation system. For example, the low water pressure, medium water pressure, or high water pressure may be determined by classifying a spectrogram generated from sound captured by the microphone of the washing machine appliance using a machine learning image analysis process.

In various instances, determining the status of the fluid circulation system of the washing machine appliance based on the analysis of the sound may include determining an abnormal status. Such abnormal status may include water not flowing through the valve (which may be due to the valve not opening or not fully opening) and/or low water pressure in the conduit. When the abnormal status is determined, embodiments of the present disclosure may include providing a user notification in response to the abnormal status. Such user notification may be provided locally, e.g., on the display 184 and/or one or more other components onboard the washing machine appliance, such as speaker 194, and/or remotely, such as via a user device 220 (e.g., as a text message or other similar notification via a smartphone) or home control system 210 (such as an audible notification from a smart speaker). For example, the user notification may be or may include a notification that the water valve has malfunctioned and/or a notification that water flow or water pressure to the washing machine appliance has changed, e.g., decreased.

Systems and methods according to the present disclosure may provide various advantages and improvements in the operation of the washing machine appliance. For example, detecting a water valve malfunction or low water pressure in real time or nearly real time may provide improved diagnostics of the washing machine operation, e.g., the abnormal status may be detected when the valve is commanded to open for an initial fill of the operation, rather than detecting the abnormal status when the operation is complete and articles in the washing machine appliance are not treated as desired, e.g., are too dry and/or dirty, or are saturated with undiluted detergent, or other undesired condition after or at the end of the operation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a washing machine appliance, the method comprising:
flowing a wash liquid into or within the washing machine appliance;
monitoring a sound with a microphone of the washing machine appliance during flowing the wash liquid;
analyzing the monitored sound; and
determining a status of a fluid circulation system of the washing machine appliance based on the analysis of the sound.

2. The method of claim 1, wherein analyzing the sound comprises generating a spectrogram of the sound and analyzing the spectrogram of the sound with an image analysis technique.

3. The method of claim 1, wherein flowing the wash liquid comprises opening a water valve.

4. The method of claim 3, wherein the washing machine appliance comprises a controller, wherein opening the water valve comprises sending an open command from the controller to the water valve, and wherein monitoring the sound with the microphone of the washing machine appliance during flowing the wash liquid comprises activating the microphone by the controller concurrently with sending the open command.

5. The method of claim 4, wherein activating the microphone by the controller concurrently with sending the open command comprises activating the microphone for a predetermined recording time.

6. The method of claim 3, wherein the status of the fluid circulation system comprises a status of the water valve.

7. The method of claim 1, wherein flowing the wash liquid comprises flowing the wash liquid through a conduit of the fluid circulation system.

8. The method of claim 7, wherein monitoring the sound during flowing the wash liquid comprises monitoring the sound at the conduit, and wherein the status of the fluid circulation system comprises a pressure within the conduit.

9. The method of claim 1, wherein determining the status of the fluid circulation system of the washing machine appliance based on the analysis of the sound comprises determining an abnormal status, further comprising providing a user notification in response to the abnormal status.

10. A washing machine appliance comprising a controller, the controller configured for:
flowing a wash liquid into or within the washing machine appliance;
monitoring a sound with a microphone of the washing machine appliance during flowing the wash liquid;
analyzing the monitored sound; and
determining a status of a fluid circulation system of the washing machine appliance based on the analysis of the sound.

11. The washing machine appliance of claim 10, wherein the controller is configured for analyzing the sound by generating a spectrogram of the sound and analyzing the spectrogram of the sound with an image analysis technique.

12. The washing machine appliance of claim 10, wherein the controller is configured for flowing the wash liquid by opening a water valve.

13. The washing machine appliance of claim 12, wherein opening the water valve comprises sending an open command from the controller to the water valve, and wherein monitoring the sound with the microphone of the washing machine appliance during flowing the wash liquid comprises activating the microphone by the controller concurrently with sending the open command.

14. The washing machine appliance of claim 13, wherein activating the microphone by the controller concurrently with sending the open command comprises activating the microphone for a predetermined recording time.

15. The washing machine appliance of claim 12, wherein the status of the fluid circulation system comprises a status of the water valve.

16. The washing machine appliance of claim 10, wherein flowing the wash liquid comprises flowing the wash liquid through a conduit of the fluid circulation system.

17. The washing machine appliance of claim 16, wherein monitoring the sound during flowing the wash liquid comprises monitoring the sound at the conduit, and wherein the status of the fluid circulation system comprises a pressure within the conduit.

18. The washing machine appliance of claim 10, wherein determining the status of the fluid circulation system of the washing machine appliance based on the analysis of the sound comprises determining an abnormal status, wherein the controller is further configured for providing a user notification in response to the abnormal status.
